(19) United States
(12) Patent Application Publication
(10) Pub. No.: US 2008/0261513 A1
(43) Pub. Date: Oct. 23, 2008

(54) Mobile Communication Terminal Capable of Playing and Updating Multimedia Content and Method of Playing the Same

(75) Inventors: Seong-Hun Shin, Seoul (KR); Sang-Bum Kim, Seoul (KR); Jeong-Ho Lee, Gyeonggi-do (KR); Young-Hoo Koh, Seoul (KR)

Correspondence Address: CANTOR COLBURN, LLP, 20 Church Street, 22nd Floor, Hartford, CT, 06103, US

(73) Assignee: NEOMTEL CO., LTD., Seoul (KR)

(21) Appl. No.: 11/577,247

(22) PCT Filed: Oct. 6, 2005
(86) PCT No.: PCT/KR05/03298

§ 371 Date: Jan. 10, 2008

(30) Foreign Application Priority Data
Oct. 18, 2004 (KR) 10-2004-0083293

(51) Int. Cl. H04H 40/00

(52) U.S. Cl. 455/3.06

(57) ABSTRACT

There is a problem in conventional technologies in that updating multimedia content can be initiated only by a mobile communication terminal side. A mobile communication terminal according to the present invention updates at least one of elements of content stored in a permanent storage area of a memory unit using update information included in an update message received through a wireless communication unit, and plays the updated content. The content can be updated from text information included in the update information, files stored in the mobile communication terminal, or network resources. Accordingly, content providers can update the content stored in the mobile communication terminal by transferring the update information of the content to be updated, for example, using an update message which is a push-type communication means such as a text message.

### TECHNICAL FIELD

The present invention relates to a mobile communication terminal that plays multimedia content and, more particularly, to a mobile communication terminal that plays multimedia content for the mobile communication terminal, which is produced in a standardized format, through a standard playback engine incorporated in the mobile communication terminal.

### BACKGROUND ART

The present applicant has provided standardized contents for standby screens of mobile communication terminals and has filed a plurality of patent applications, i.e., Korean Patent Application Nos. 2000-42840 and 2000-79982. Recently, the present applicant has also filed Korean Patent Application No. 2003-14687 on Mar. 10, 2003 (Korean Patent Publication No. 2003-87525, disclosed on Nov. 14, 2003), which relates to a technology for providing interactive multimedia content on a standby screen.

The above-mentioned publication discloses a technology for providing interactive content by checking and performing commands issued by a user whenever each frame of the content for a standby mode is played back. In order to respond to the user's commands, keys are first acquired from a key input queue. Next, it is determined whether or not there is an action which corresponds to the acquired key and is previously defined as part of the content. If the action exists, the action is carried out. Examples of the action include controls related to playing back the content, such as jump, repetitive play, fast play or rewind, a vibration command, a sound output command, and the like.

The present applicant has further improved the above-mentioned technology, and has filed Korean Patent Application No. 2004-80525, filed on Oct. 8, 2004, which relates to dynamic updating of the multimedia content. The specification of this application discloses a mobile communication terminal which monitors an occurrence of an event, changes at least one of elements of a played content file to a new element when the event occurs, and plays the content file having the changed element by means of a playback unit. The elements of the content are objects such as network resources or images taken by a camera. The elements can be updated automatically or manually by users. Accordingly, it is possible to produce various types of multimedia contents.

However, there is a problem in these technologies in that updating the multimedia content can be initiated only by the mobile communication terminal side.

### DISCLOSURE OF INVENTION

### Technical Solution

It is an object of the present invention to provide a mobile communication terminal that plays content that can change.

It is another object of the present invention to diversify functions of content played in a mobile communication terminal.

### Advantageous Effects

The mobile communication terminal according to the present invention can play content that can be changed by content providers, thereby providing server-push type content. Accordingly, it is possible to diversify functions of the content played in the mobile communication terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a system for providing a multimedia content service according to an embodiment of the present invention;

FIG. 2 is a block diagram of a mobile communication terminal according to an embodiment of the present invention;

FIG. 3 is a flow chart of a method of playing multimedia content according to an embodiment of the present invention;

FIG. 4 is a flow chart of a method of playing multimedia content according to another embodiment of the present invention;

FIG. 5 is a flow chart of a method of providing multimedia content according to an embodiment of the present invention; and

FIGS. 6 and 7 show examples of multimedia content according to an embodiment of the present invention.

### BEST MODE FOR CARRYING OUT THE INVENTION

According to an aspect of the present invention, there is provided a mobile communication terminal which updates at least one of elements of content stored in a permanent storage area of a memory unit using update information included in an update message received through a wireless communication unit, and plays the updated content.

Accordingly, a content provider can update the content stored in the mobile communication terminal by transferring the update information of the content to be updated, for example, using an update message which is a push-type communication means such as a text message.

The mobile communication terminal having received the update message may update an object file constituting the content using text information included in the update information.

Accordingly, the content provider can substitute part of existing content by his/her desired data, or add the desired data to the existing content through the message.

The mobile communication terminal having received the update message may update the content by accessing a predetermined network resource through the wireless communication unit under the control of playback control commands and updating an object file specified by the update information.

Accordingly, the content provider can substitute part of existing content by his/her desired items, or add the desired items to the existing content.

Access information concerning an access to the network resource may be included in the update information. The access information may be preset as part of the playback control command of the content.

The update message and its reception may be checked while the content file is being played by the playback control command such as a script included in the content, for example, before/after generating and/or outputting each frame. Alternatively, the update message and its reception may be checked in response to an event for receiving messages by a control program which resides in the mobile communication terminal.

### MODE FOR THE INVENTION

Exemplary embodiments in accordance with the present invention will now be described in detail with reference to the accompanying drawings.

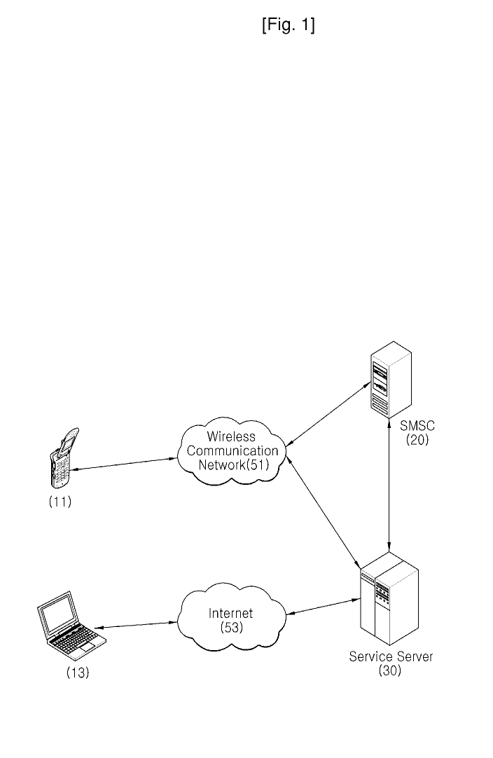

FIG. 1 is a system for providing a multimedia content service according to an embodiment of the present invention. The system for providing a multimedia content service includes a mobile communication terminal 11, a computer 13, a short message service center (SMSC) 20, and a service server 30. The service server 30 provides content. The SMSC 20 transfers an update message, which includes update information concerning a part of content required to be updated by an update request of the service server, to a designated mobile communication terminal. The mobile communication terminal 11 downloads content from the service server 30 over a wireless communication network 51, receives the update message from the SMSC 20, and downloads a file from the service server 30 to update the content. The computer 13 allows a user to access the service server 30 over the Internet 53 to purchase content or an item to update the content, or reserve update information.

Examples of the mobile communication terminal 11 include a folder-type mobile phone, a personal digital assistant (PDA), a portable audio player, a portable multimedia player, and the like. For example, recently, a MP3 player or a personal multimedia player (PMP) may access a personal computer through a USB port and access a host computer over a network under the control of a browser.

In the present embodiment, the wireless communication network 51 includes a base transceiver station and a base station controller, which support voice and data communications, and a packet data serving node (PDSN) and a packet control function (PCF), which are responsible for interface with an IP network. The wireless communication network 51 may be a wireless LAN. In this case, the mobile communication terminal 11 accesses a host computer over the wireless LAN to download or update content.

The service server 30 includes a web server for the Internet 53, a WAP server for the wireless communication network 51, and a plurality of media database server for storing contents. The service server 30 is connected to the SMSC 20 to push information to the mobile communication terminal 11.

For example, the service server 30 may be a server which provides content for making a personal homepage for a mobile phone. In this case, when a user accesses to the service server 30 through the computer 13 or the mobile communication terminal 11, the service server 30 shows and sells various contents and downloads the content to the mobile communication terminal 11. When the user desires to add some items to the content, the user accesses to the service server 30 through the computer 13 or the mobile communication terminal 11 and purchases the items. At this time, update information concerning the purchased items is transferred through the SMSC 20.

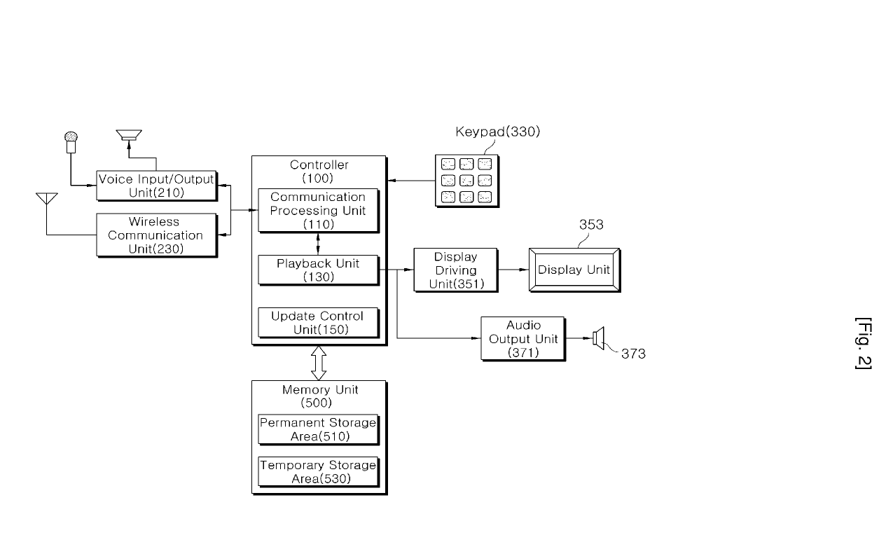

FIG. 2 is a block diagram of a mobile communication terminal according to an embodiment of the present invention. The mobile communication terminal includes a communication processing unit 110, a voice input/output unit 210, a wireless communication unit 230, and a memory unit 500. The wireless communication unit 230 transmits/receives voice and data signals through a mobile communication network. The communication processing unit 110 processes the voice and data signals transmitted/received through the wireless communication unit 230. The voice input/output unit 210 converts the voice signal processed by the communication processing unit 110 into an audible sound, or converts a voice signal inputted from the outside and transmits it to the communication processing unit 110. The memory unit 500 stores content data.

The mobile communication terminal further includes a playback unit 130, an update control unit 150, a keypad 330, a display unit 353, and an audio output unit 371. The playback unit 130 checks whether or not elements of content to be played are present in a permanent storage area 510 of the memory unit 500, loads the elements into a temporary storage area 530 of the memory unit 500, and, if there are updated elements, loads the updated elements into the temporary storage area 530. The display unit 353 displays images played back in the playback unit 130. The audio output unit 371 outputs audio signals played back in the playback unit 130. The update control unit 150 is operated when the playback unit 130 is activated, monitors whether or not an event occurs, changes at least one of the elements of the content file to be played to a new element when the event occurs, and notifies the playback unit 130 that the elements have been updated.

The wireless communication unit 230 includes an antenna and a radio frequency (RF) circuit to communicate with base stations. The voice input/output circuit 210 transfers received voice to a user, converts a user's voice which is input from a microphone, and converts digital voice data into an analog voice signal and vice versa. The voice input/output circuit 210 includes an audio amplifier, a filter, or the like.

The keypad 330 allows a user to enter data. Examples of the keypad 330 include a key button of a mobile communication terminal and a touch panel of a personal digital assistant (PDA). The display unit 353 may be a liquid crystal display (LCD) device. Image data outputted from the playback unit 130 is processed in the display driving unit 351 and converted into an analog signal for driving the display unit 353. The term “display unit” may refer to a device including a display driving unit or the like.

The audio output unit 371 converts the audio signal played by and outputted from the playback unit 130 into an audio signal and outputs the audio signal through a speaker 373. The audio output unit 371 includes a digital/analog converter, an amplifier, or the like.

The memory unit 500 may be composed of a single or a plurality of memory modules. The permanent storage area 510 may be a non-volatile memory, such as a read-only memory (ROM). The temporary storage area 530 may be a volatile memory, such as a random access memory (RAM). Both of them 510 and 530 may be provided as a single flash memory. In the present specification, the permanent storage area 510 implies a storage area in which data is preserved for a relatively long period of time even when power turns off. On the other hand, the temporary storage area 530 implies a storage area in which data is removed when power turns off.

The communication processing unit 110 decodes a signal received from the wireless communication unit 230 into digital voice/non-voice data, or vice versa. A baseband circuit of the wireless communication unit 230 and most circuits of the controller 100 are integrated into a commercially available IC chip. The IC chip includes hardware for communication processing, a digital signal processor, and a general-purpose microprocessor.

The playback unit 130 includes a playback engine for playing content, and a content file which is executed by the playback engine. The playback engine is incorporated in the mobile communication terminal, and reads the content stored in the permanent storage area 510 of the memory unit 500 into the temporary storage area 530 and plays the content.

The content stored in the permanent storage area 510 includes a header, which includes summary information concerning the content, object files, which are elements of the content to be played, and a playback control command. Examples of the object files include image files, sound files, or moving image files.

The playback engine of the playback unit 130 reads a content file from the permanent storage area 510 of the memory unit 500 into the temporary storage area 530, loads the object files from the information included in the header into a resource area, reads the playback control command into an action area, sequentially reads and plays the object files loaded in the resource area according to the playback control command stored in the action area, and, when the content is updated, loads the updated file into the temporary storage area and plays the updated file. The term “action” in the present invention implies a sequence of playback control commands which constitute a single operation. Accordingly, when one of the object files constituting original content changes to another file, which has the same file name as but different data than an original file, and is stored in the permanent storage area 510, the changed content is played back afterwards.

For example, the playback control commands control a display order of a series of frames, or a delay time of the series of frames, and define content to be displayed in each frame. The respective frames may be displayed by overlapping images of a plurality of layers with transparent margins on a background image. In addition to the images, sounds can be also controlled in synchronization with playback of each frame. Accordingly, it is possible to produce various multimedia contents by combining the playback control commands and the object files.

The update control unit 150 updates at least one of elements of the content stored in the permanent storage area of the memory unit using update information included in the update message received through the wireless communication unit, and notifies the playback unit 130 that the content has been updated. In the present specification, the term “update” implies that the content is changed due to substitution of existing elements with new elements, addition of new elements to the content, and the like. For example, elements updated or added by an update message may be at least one of object files that constitute the content.

When an object file constituting content is substituted by another file having the same file name, for example, by downloading or uploading the file, the playback unit 130 uploads a file stored in the permanent storage area 510 of the memory unit 500 to play the updated file.

In one embodiment, the operation of the update control unit 150 is defined by part of the playback control command included in the content. The update control unit 150 may be one of control programs which are run in the mobile communication terminal.

In another embodiment, the update control unit 150 may be a routine executed as an independent thread which is operated when the playback unit 130 is activated. The update control unit 150 updates the object and notifies the playback unit 130 that the content has been updated. The playback unit 130 reads the updated object file or the content file from the permanent storage area 510 into the temporary storage area 530, and plays the updated content. Accordingly, it is possible to change and play the content while the content is played. The update control unit 150 manages a script which defines a definition of an event and an action corresponding to the defined event, and monitors an occurrence of the defined event. When the event occurs, the update control unit 150 executes an action which corresponds to the event.

In another embodiment, the update control unit 150 may be a conceptual expression of playback control commands which are distributed in the playback unit 130. That is, among the playback control commands, a command to generate a frame and/or a command to output the generated frame includes a definition of an event which causes execution of a script that defines a specified action. For example, when a ‘SEND’ button of a mobile phone is pushed while the playback engine is playing a specified content, a command to generate a frame executes a predetermined script in response to this event. The script may be configured to update part of an object of the content which is currently played through a network.

The update information included in the update message received through the wireless communication unit specifies an object file to be updated. The update control unit 150 accesses a predetermined network resource through the wireless communication unit under the control of playback control commands, receives and updates the specified object file. For example, the update control unit 150 analyzes a received short message and determines from a specific keyword included in the message that the message is related to updating the content. The update control unit 150 acquires, from the received short message, identification information concerning currently stored content and identification information concerning an object file required to be updated in the content, and accesses to a network resource using the identification information to request the object file. Accordingly, the content is changed to the received file.

Information concerning access to the network resource may be acquired from at least one of the playback control commands included in the content.

The following is an example of a script for accessing the network resource through the wireless communication unit 230, receiving and updating the content or object files that constitute the content:

ext_importMovie(“http://211.233.24.178/vis20Dm/files/photones1.vis “,” newm”, “loading”, “nerror”);

ext_replaceMovieClip(“oldm”, “newm”)

ext_saveResource(“newm”)

The function ext_importMovie( ) is a function of receiving a file from a network and making it a movie clip symbol. The function ext_replaceMovieClip( ) is a function of replacing an existing movie clip with the movie clip symbol received from the network. The function ext_saveResource( ) is a function of storing the movie clip symbol in the permanent storage area 510, and allowing the updated movie clip information to be played. When the function ext_importMovie( ) is executed, a mobile communication terminal requests and receives a corresponding file from URL, which is defined in a parameter, using the HTTP protocol. If the replaced movie clip information is not stored in the permanent storage area 510, the content, which is not updated and is stored in the permanent storage area 510, will be played back.

Information concerning access to the network resource may be acquired from update information included in an update message received through the wireless communication unit.

The update information included in the update message received through the wireless communication unit is text information, and the update control unit 150 changes at least part of a text of an object file constituting content to the text information under the control of the playback control commands.

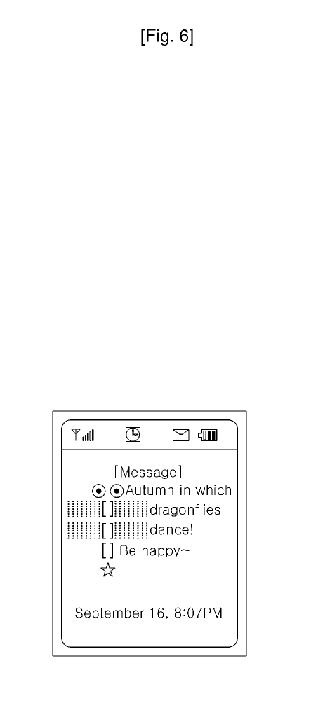

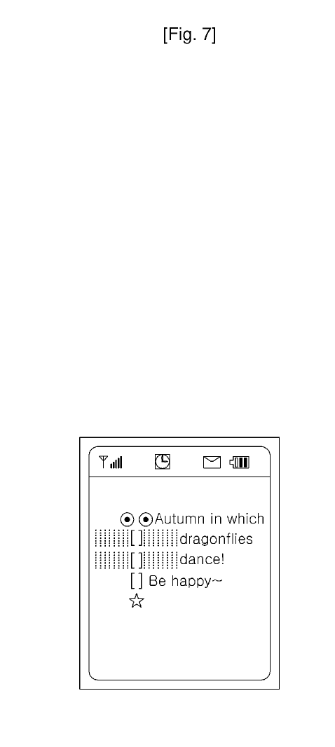

FIGS. 6 and 7 show examples of multimedia content according to an embodiment of the present invention. After receiving a text message as shown in FIG. 6, the text message is analyzed under the control of a control program residing in a mobile phone or a playback control command included in the content, and the text is recognized to be overlapped with a picture, which is a background image shown in FIG. 7, from a specific keyword and identification information included in the text message. Subsequently, the text is extracted from the text message. The text is overlapped with the background image which is stored beforehand, and played as shown in FIG. 7.

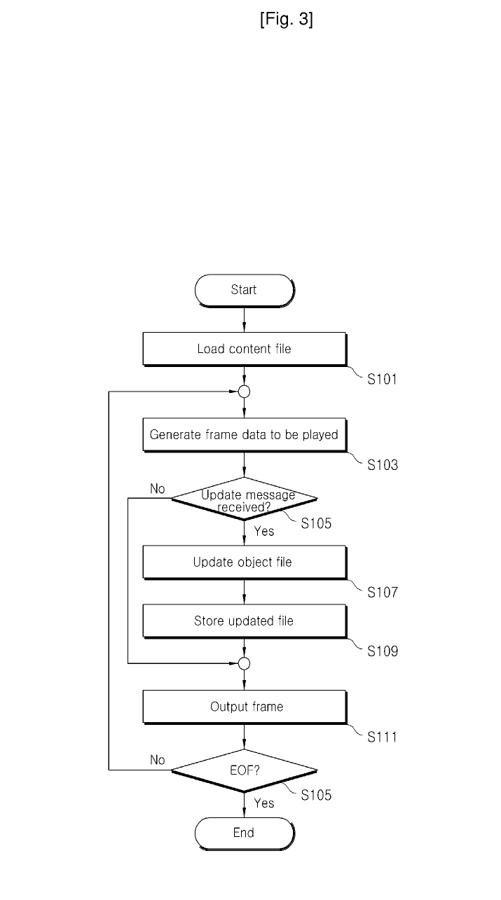

A method of playing multimedia content in a mobile communication terminal according to another embodiment of the present invention will now be described in detail with reference to FIG. 3. FIG. 3 is a flow chart of a method of playing content according to an embodiment of the present invention. The method includes the operations of sequentially reading object files included in a content file according to playback control commands included in the content file (operation S101), generating frame data to be played (operation S103), checking whether or not there is an update message related to the content in a received message (operation S105), if the update message is present, updating at least one of elements included in the content file using update information included in the update message (operation S107), and outputting the generated frame data (operation S111).

The content file includes a header which has summary information concerning the content, object files which are elements of the multimedia content to be updated, and a playback control command. Each object file may be at least one of image files, sound files, and moving image files. The content files may be recorded on a storage unit such as a ROM or a hard disk of a host computer, and may be transferred through a network. The content file may be compressed into a single file to reduce the file size. The present invention includes a recording medium that stores the content thus configured.

The playback unit 130 reads the content file stored in the permanent storage area 510 of the memory unit into a temporary storage area. When a file is compressed and stored, an operation of decompressing the compressed file may be added before reading the compressed file. The playback unit 130 loads the object files from information included in the header into a resource area, and reads the playback control command into an action area (operation S101).

Next, the playback unit 130 sequentially reads the object files loaded into the resource area according to the playback control command stored in the action area and generates frame data to be played (operation S103). In order to play a single frame, a plurality of object files, such as a plurality of image files, which constitute a plurality of layers of each frame, and a sound file, which is played in synchronization with the frame, may be related.

The update control unit 150 checks whether or not there is an update message including update information in a received message (operation S105). A common SMS supports so that other application programs can access and check the message. When a specific keyword is included in the received common SMS, the update control unit 150 recognizes the message as an update message. The update control unit 150 identifies content to be updated from content identification information included in the update message.

Next, when there is an update message, the update control unit 150 changes the content or at least one of elements of the content file, which is stored in the resource area, to a new element using the update information included in the update message. In this case, the update control unit 150 updates content stored in the temporary storage area 530 of the memory unit 500. Next, the playback unit 130 outputs the generated frame data (operation S111).

According to the present invention, in response to a reception event of the update message, the playback unit 130 can load and play an object file specified by the update message among the content or object files of the content stored in the permanent storage area 510 of the memory unit 500. Accordingly, the content can change while it is being played. For example, the content includes a plurality of object files and the update message may be a message to specify one of the object files. In this case, the content to be output may vary according to the received update message.

In the present embodiment, the operation of checking and updating the message, which is performed in the update control unit 150, is preferably performed before and/or after each frame is generated, since the frames are frequently output at regular speeds. If there is no update information related to currently played content in the received message, a frame generated without the above-mentioned action is directly output (operation S111).

After the operation S107, operation S109 is further included in which an element of the updated content file substitutes corresponding content or an element of the content which is stored in the permanent storage area 510 of the memory unit 500. Accordingly, when the playback engine is terminated and restarted, the updated content is loaded and played. The playback unit 130 checks the playback control command to determine whether or not the content file is played. If the playback operation of the content file is not completely terminated, it returns to operation S103. Otherwise, the process is terminated (operation S105).

In one embodiment of the operation S107, when receiving an update message to update currently played content, the update control unit 150 changes at least one of elements of the content file to a file received by accessing an address of the network resource included in the update message.

The update information included in the update message includes information specifying the object file of the content to be updated. The update control unit 150 accesses a predetermined network resource under the control of a script, which is the playback control commands stored in the action area, receives and updates the specified object file.

The update information may further include information concerning an access to the network resource. In this case, the network access information is acquired from the received update message. The information concerning an access to the network resource may be acquired from at least one of the playback control commands.

According to an embodiment of the present invention, operation of changing at least one of elements of a content file to a new element using the update information, operation of generating frame data having the updated element, and operation of outputting the generated frame data may be repeated several times. The network resource connected using the update information includes a plurality of objects, and the update control unit 150 substitutes these by corresponding elements. Accordingly, it is possible to output the content having a series of frames which are updated differently. For example, in playing content for a cartoon, a series of cartoon scenes can be sequentially generated and played upon accessing to a network.

In another embodiment of the operation S107, the update information includes text information, and the update control unit 150 changes at least part of an object file to the received text information. Accordingly, as shown in FIGS. 6 and 7, added or updated text of the content may be played.

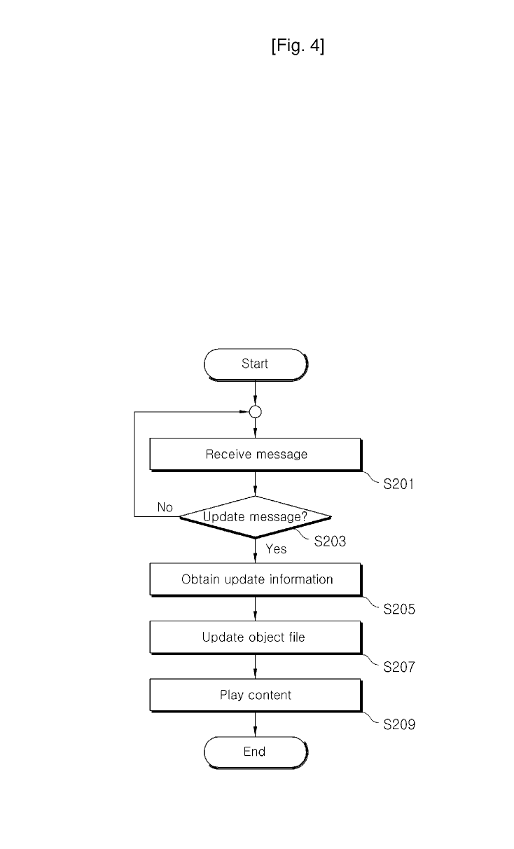

FIG. 4 is a flow chart of a method of playing content according to another embodiment of the present invention. In the present embodiment, when a mobile communication terminal receives a message (operation S201), it checks whether or not the message includes update information related to updating the content (operation S203). When the update information is included, the update information is acquired from the message (operation S205). Since the message is a text message, required information can be easily extracted. Next, at least one of object files of the content file is changed to a new element using the update information (operation S207). The object files included in the updated content file is sequentially read and played according to playback control commands included in the updated content file (operation S209).

In the present embodiment, the update control unit 150 resides on a memory as an independent program, and checks whether or not there is an update message including update information in the received message (operations S201 and S203). A common SMS supports so that other application programs access and check the message. When a specific keyword is included in the received common SMS, the update control unit 150 recognizes the message as an update message. The update control unit 150 identifies content to be updated from content identification information included in the update message.

Next, when there is an update message, the content or at least one of elements of the content file, which is stored in the permanent storage area of the memory unit, is changed to a new element using the update information included in the update message.

The content file includes a header which has summary information concerning the content, object files which are elements of the multimedia content to be updated, and a playback control command. Each object file may be at least one of image files, sound files, and moving image files. The content file may be compressed into a single file to reduce the file size.

The playback unit 130 reads the content file stored in the permanent storage area 510 of the memory unit into a temporary storage area. When a file is compressed and stored, an operation of decompressing the compressed file may be added before reading the compressed file. The playback unit 130 loads the object files from information included in the header into a resource area, and reads the playback control command into an action area.

Next, the playback unit 130 sequentially reads the object files loaded into the resource area according to the playback control command stored in the action area and generates frame data to be played. In order to play a single frame, a plurality of object files, such as a plurality of image files, which constitute a plurality of layers of each frame, and a sound file, which is played in synchronization with the frame, may be related. Next, the playback unit 130 outputs the generated frame through a display and a speaker.

In one embodiment of the operation S207, when receiving an update message to update currently played content, the update control unit 150 changes at least one of elements of the content file to a file received by accessing an address of the network resource included in the update message.

The update information included in the update message includes information specifying the object file of the content to be updated. The update control unit 150 accesses a predetermined network resource under the control of a script, which is the playback control commands stored in the action area, receives and updates the specified object file.

The update information may further include information concerning an access to the network resource. In this case, the network access information is acquired from the received update message. The information concerning an access to the network resource may be acquired from at least one of the playback control commands.

According to an embodiment of the present invention, operation of changing at least one of elements of the content file to a new element using the update information, operation of generating frame data having the updated element, and operation of outputting the generated frame data may be repeated several times. The network resource connected using the update information includes a plurality of objects, and the update control unit 150 substitutes these by corresponding elements. Accordingly, it is possible to output the content having a series of frames which are updated differently. For example, in playing content for a cartoon, a series of cartoon scenes can be sequentially generated and played upon accessing to a network.

In another embodiment of the operation S207, the update information includes text information, and the update control unit 150 changes at least part of an object file to the received text information. Accordingly, as shown in FIGS. 6 and 7, added or updated text of the content may be played.

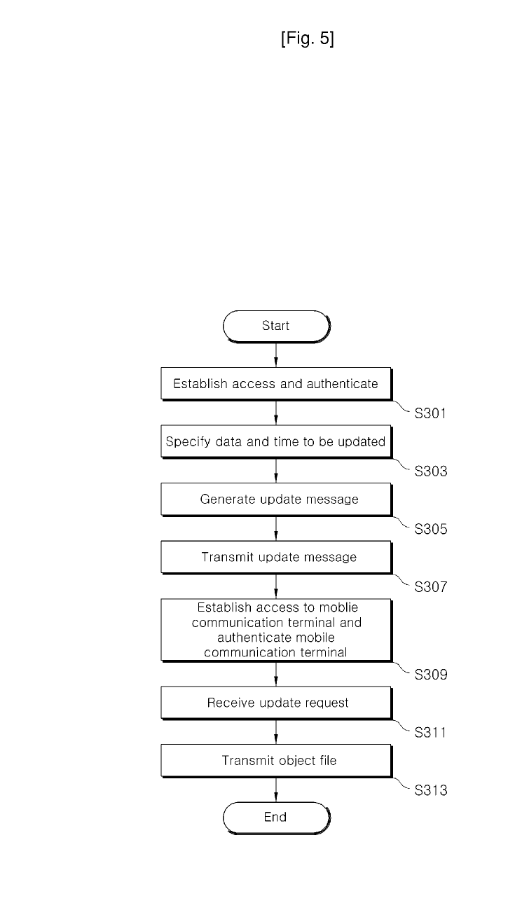

FIG. 5 is a flow chart of a method of providing multimedia content according to another embodiment of the present invention. The operation of the SMSC 20 and the service server 30 of FIG. 1 will now be described in detail with reference to FIG. 5.

Information concerning an object file of content to be updated is acquired from the computer 13 connected over the Internet 53. A web server, which constitutes the service server 30, establishes access to a user's computer and performs an authentication process using ID and password (operation S301). The web server receives information concerning updated data and update time of the content from the computer 13. The information includes the updated data, such as a phone number of the mobile communication terminal, content to be updated, and a file name of an object file of the content to be updated, the time to be updated, and repetitive update (operation S303).

For example, the service server 30 may be a content shopping mall. For example, when a user purchases avatar items such as sunglasses, clothes, or caps in an avatar mall, the purchased items become update information.

The service server 30 generates an update message using the information received by the web server (operation S305). The update message may further include information such as “Items purchased in the avatar mall will be provided. If you want to receive them, press a SEND button.”

According to an embodiment of the present invention, the method of providing the multimedia content includes transmitting an update message including update information including information for specifying an object file of content to a designated mobile communication terminal through the SMSC 20 (operation S307). When the content is played by a user having received the message, or the user's mobile communication terminal accesses to a WAP server of the service server 30 by an application program residing on a memory unit, the WAP server establishes access to the mobile communication terminal and authenticates the mobile communication terminal (operation S309). Subsequently, an update request to update the object file is received from the mobile communication terminal (operation S311), and the requested object file is transmitted (operation S313).

The update message may be automatically transferred at regular intervals according to a user's instruction or content. For example, content for weather forecast may be set to be repeatedly transferred at regular intervals.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be applied to a mobile communication field in which a mobile communication terminal plays multimedia content for the mobile communication terminal, which is produced in a standardized format, through a standard playback engine incorporated in the mobile communication terminal.

1. A mobile communication terminal which plays multimedia content, comprising:
a wireless communication unit that transmits/receives data signals through a mobile communication network;
a memory unit that stores the content;
a playback unit which loads elements of the content stored in a permanent storage area of the memory unit into a temporary storage area of the memory unit, and, if there is an updated element, loads the updated element into the temporary storage area and plays the updated element;
a display unit that displays an image played by the playback unit;
an audio output unit that outputs an audio signal played by the playback unit; and
an update control unit which updates at least one of elements of the content stored in the permanent storage area of the memory unit using update information included in an update message received through the wireless communication unit, and notifies the playback unit that the element has been updated.

2. The mobile communication terminal of claim 1, wherein the content comprises:
a header including summary information of the content;
object files which are elements of multimedia content to be played; and
a playback control command.

3. The mobile communication terminal of claim 2, wherein at least part of the object files is any one of an image file, a sound file, and a moving image file.

4. The mobile communication terminal of claim 3, wherein the update information specifies the object file, and the update control unit accesses a predetermined network resource through the wireless communication unit under the control of the playback control commands, receives and updates the specified object file.

5. The mobile communication terminal of claim 4, wherein the update information further includes information concerning an access to the network resource.

6. The mobile communication terminal of claim 4, wherein the information concerning an access to the network resource is acquired from at least one of the playback control commands.

7. The mobile communication terminal of claim 3, wherein the update information is text information, and the update control unit changes at least part of the text of the object file to the text information under the control of the playback control commands.

8. A method of playing multimedia content, the method comprising the operations of:
a) sequentially reading object files included in a content file and generating frame data to be played according to playback control commands included in the content file;
b) checking whether or not there is an update message related to the content in a received message;
c) when there is the update message, changing at least one of elements of the content file to a new element using update information included in the update message; and
d) outputting generated frame data.

9. The method of claim 8, wherein the update information includes information related to specifying an object file, and, in the operation c), a predetermined network resource is accessed and the specified object file is received and updated.

10. The method of claim 9, wherein the update information further includes information concerning an access to the network resource.

11. The method of claim 9, wherein the information concerning an access to the network resource is acquired from at least one of the playback control commands.

12. The method of claim 8, wherein the operations c) and d) include:
c1) changing at least one of elements of the content file to a new element using the update information;
d1) generating frame data having the updated element; and
d2) outputting the generated frame data, and wherein when the update information is included, the operations c1), d1), and d2) are repeated several times.

13. The method of claim 8,
wherein the update information includes text information, and
wherein in the operation c), when the update information is included, at least part of the text of the object file is changed to the received text information.

14. A method of playing multimedia content, the method comprising the operations of:
l) receiving a message;
m) checking whether or not the message includes update information related to updating content;
n) when the message includes the update information, changing at least one of object files which constitute a content file to a new element using the update information; and
o) sequentially reading and playing the object files included in the updated content file according to playback control commands included in the content file.

15. The method of claim 14, wherein the update information includes information related to specifying an object file, and, in the operation n), a predetermined network resource is accessed and the specified object file is received and updated.

16. The method of claim 15, wherein the update information further includes information concerning an access to the network resource.

17. The method of claim 17, wherein the information concerning an access to the network resource is acquired from at least one of the playback control commands.

18. The method of claim 14,
wherein the operations n) and o) include:
n1) changing at least one of elements of the content file to a new element using the update information;
o1) generating frame data having the updated element; and
o2) outputting the generated frame data, and
wherein when the update information is included, the operations n1), o1), and o2) are repeated several times.

19. The method of claim 14,
wherein the update information includes text information, and
wherein in the operation c), when the update information is included, at least part of the text of the object file is changed to the received text information.

20. A method of providing multimedia content, the method comprising the operations of:
transmitting an update message including update information including information related to specifying object files constituting content to a designated mobile communication terminal; and
receiving an update request to update the object file from the mobile communication terminal and transmitting the object file.

21. The method of claim 20, further comprising receiving the information related to specifying the object files constituting the content from a user's mobile communication terminal which accesses through the Internet.

22. The method of claim 21, wherein the update message further includes delivery information related to delivering items of the content purchased by a user.

23. The method of claim 20, further comprising receiving information concerning updated data and update time of the content from a user's mobile communication terminal which accesses through the Internet.

24. The method of claim 23, wherein the update message is automatically forwarded at regular intervals.

25. The method of claim 20, wherein the update information further includes access information concerning an access to the network resource.
